(19) United States
(12) Patent Application Publication
(10) Pub. No.: US 2011/0274864 A1
(43) Pub. Date: Nov. 10, 2011

(54) Magnetic label stock material

(76) Inventor: Keith Medley, Marietta, OH (US)

(21) Appl. No.: 10/579,786

(22) PCT Filed: Feb. 19, 2003
(86) PCT No.: PCT/US03/04507

§ 371 Date: Jan. 12, 2011

Related U.S. Application Data
(60) Provisional application No. 60/358,352, filed on Feb. 22, 2002.

(51) Int. Cl. B32B 33/00

(52) U.S. Cl. 428/41.8

(57) ABSTRACT

A magnetic label stock material (100) for applying magnetic labels (108) to a substrate includes a flexible translucent release tape (102) having magnetic labels (108) adhered thereto with a pressure sensitive adhesive. The magnetic labels (108) are spaced along said tape (102) with light-transmissive gaps therebetween, and the magnetic labels (108) extend substantially to the edges (106) of said tape (102) in order to support and reinforce the edges (106) of the tape (102) and prevent damage to the tape (102) in handling and use.

### BACKGROUND OF THE INVENTION

1. Field of the Invention:

This invention relates to magnetic labels and more particularly to a stock material for applying magnetic labels to a substrate.

2. Brief Description of the Prior Art:

Thin flexible magnetic labels, flexible magnets for supporting papers and the like, and small magnetic signs are commonly distributed in commerce as attachments to substrates such as paper, cardboard and the like. The thin flexible magnetic articles are typically applied to the substrate with conventional label application machines and adhered to the substrate by an adhesive, e.g., a pressure-sensitive adhesive. The magnetic articles are supplied to the applicator machine in the form of a thin, flexible tape having the magnets arranged sequentially thereon. The magnets have a pressure-sensitive adhesive coating on the side facing the tape by which they are adhered to the tape. The tape, which may be paper, or a synthetic resin web, such as polyethylene, polypropylene or polyester, has a release surface, i.e., a surface that will allow the magnet to be easily removed therefrom with the pressure-sensitive adhesive remaining on the back of the magnet. If the tape material does not naturally have a release surface, it may be treated with a material, e.g., a silicone, to give it release properties. Such release tapes are conventional in the art.

Typically, the labels or magnets on such supply tapes do not extend to the extreme edges of the tape. For paper labels, which are relatively thin, perhaps 0.003-0.005 inches thick, a tightly coiled roll of stock tape may be formed and handled. However, the magnets applied by the conventional label technique typically range from about 0.006 to about 0.060 inches in thickness. With such thicker materials, the edges of the tape extending beyond the edges of the magnets are relatively widely spaced when the tape is coiled for distribution and handling. Consequently, the thin paper edges of the rolls are often bent, crushed, distorted, or even torn in the course of the handling necessary to distribute the rolls and mount them on the labeling machine. Such distorted edges present problems with the smooth operation of the labeling machine because they may not interact properly with the guides and/or may get caught in the labeling machine.

Accordingly, a need has continued to exist for a stock material for application of magnetic labels and the like that does not suffer from the deficiencies of the already known materials.

### SUMMARY OF THE INVENTION

The deficiencies of conventional magnetic label stock materials, have now been alleviated by the material of the invention comprising

a flexible translucent release tape having magnetic labels adhered thereto with a pressure sensitive adhesive,

the magnetic labels being spaced along said tape with light-transmissive gaps therebetween, and

the magnetic labels extending substantially to the edges of said tape.

Accordingly, it is an object of the invention to provide a magnetic label stock tape.

A further object is to provide a magnetic label stock tape wherein the edges of the tape are less prone to damage in handling.

Further objects of the invention will become apparent from the description of the invention which follows.

### BRIEF DESCRIPTION OF THE DRAWINGS

FIG. 1 illustrates a plan view of a section of the magnetic label stock tape of the invention.

FIG. 2 illustrates a side elevational view of the magnetic label stock tape of the invention.

FIG. 3 illustrates a coil of the magnetic label stock tape of the invention.

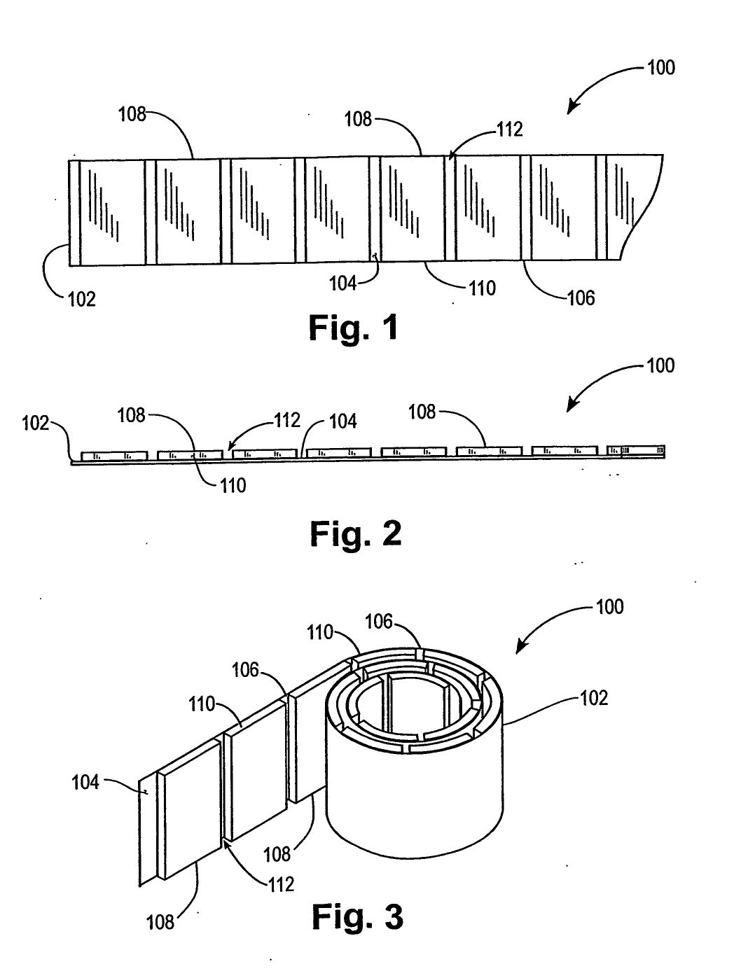

### DETAILED DESCRIPTION OF THE INVENTION AND PREFERRED EMBODIMENTS

The magnetic label stock tape 100 of the invention will be described with reference to the figures of the drawings. The stock tape 100 includes a flexible translucent substrate 102, which has a release surface at least on the upper surface 104 on which the magnetic labels 108 are carried. The tape may be made from a synthetic resin, e.g., polyethylene, polypropylene, polyester, or the like. The tape may also be made of a non-woven web, such as paper, having a release coating, e.g., a silicone coating, on its upper surface 104, as is known to those skilled in the art. It is not excluded that the tape may be made of a woven material, e.g., cloth, or the like, having a release coating on its upper surface 104, if necessary. A preferred material for the flexible translucent substrate 102 is a polyester, e.g., poly(ethylene terephthalate), and a more preferred embodiment is mineral filled polyester.

The magnetic labels 108 may be any conventional flexible magnetic label. Such labels are made from suspensions of magnetizable material, e.g., an appropriate ferrite, dispersed in a flexible synthetic resin or rubber binder, and subsequently magnetized. Such flexible magnetic labels are well-known and widely used. Typically the magnetic labels 108 range from about 0.006 inches to about 0.060 inches in thickness.

The magnetic labels 108 are fixed to the upper surface 104 of the tape with a thin layer of a pressure-sensitive adhesive (not shown) on the back of each label 108. The magnetic labels 108 are spaced along the longitudinal direction of the tape 102 with small intervals 112 between them. The tape 102 itself is translucent. Accordingly, the conventional optical sensing devices that control the movement of the tape 102 through the labeling machine can operate in their normal fashion.

The magnetic labels 108 have a dimension in the lateral direction of the tape 102, i.e., at right angles to the longitudinal direction of the tape 102, that is generally equal to the width of the tape in the lateral direction. Accordingly, the labels are sized to extend substantially to the lateral edges 106 of the tape 102. Consequently, the relatively thin and delicate edges 106 of the tape 102 are supported along most of their length by the lateral edges 110 of the magnetic labels 108. This tends to prevent crushing, distortion, or tearing of the tape substrate 102 when a coil of the stock material 100 is distributed and handled. This arrangement of the magnetic labels also allows the edge guides in the label application machine to bear for the most part on the edge 110 of the magnetic label and the portion of the edge 106 of the tape 102 reinforced by contact with the magnetic label. Accordingly, the tape 102 tends to run more smoothly through the label application machine.

When the stock material 100 is coiled for shipping, distribution, etc., as shown in FIG. 3, the lateral edges 110 of the magnetic labels 108 substantially coincide with the lateral edges 106 of the tape 102. Consequently the edges 106 of the tape 102 are largely protected from damage in handling and use.

The invention having now been fully described, it should be understood that it may be embodied in other specific forms or variations without departing from its spirit or essential characteristics. Accordingly, the embodiments described above are to be considered in all respects as illustrative and not restrictive, the scope of the invention being indicated by the appended claims rather than the foregoing description, and al changes which come within the meaning and range of equivalence of the claims are intended to be embraced therein.

1. A magnetic label stock tape wherein the edges of the tape extending beyond the edges of the magnet are less prone to damage in handling in labeling machines consisting essentially of:
a) a translucent tape having a longitudinal direction and a transverse direction and a dimension in said transverse direction, and having at least one major release surface; and
b) a plurality of magnetic labels, each of said magnetic labels having at least one major surface at least partially covered with a pressure sensitive adhesive, said labels being fixed on said release surface by means of said pressure-sensitive adhesive;
wherein said labels being spaced in said longitudinal direction by a distance sufficient to permit transmission of an optical signal through said tape between said magnetic labels, and
wherein at least some of said tape having a dimension in said transverse direction substantially equal or extending beyond said transverse dimension of the magnet.
